(19) United States
(12) Patent Application Publication
(10) Pub. No.: US 2004/0136030 A1
(43) Pub. Date: Jul. 15, 2004

(54) Print job management system

(76) Inventor: Kazuhito Gassho, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/617,480

(22) Filed: Jul. 10, 2003

(30) Foreign Application Priority Data
Jul. 26, 2002 (JP) 2002-218295

(51) Int. Cl. G06F 15/00; G06F 3/12

(52) U.S. Cl. 358/1.15; 718/100; 358/1.16

(57) ABSTRACT

A two-way type print job is made movable in a load sharing print system.

When a print job that requires a two-way communication is received from a client CL1, a printer PT1 only stores job information in a spooler SP1. In the process of load sharing, a move processing module 104 inputs into a job control module 105 an instruction for moving the print job. In case where the job information is to be moved, the move control module 104 also provides a notification of change to the client CL1, which is the submitter of the job. The instruction for moving at least includes address information of a printer PT2, which is the destination of the move, and an instruction for switching the destination of the communication. When the instruction for moving is received, the job control module 106 moves the job information from the spooler SP1 to a spooler SP2, as indicated by dashed arrows. The client CL1 receives the notification of change, switches the destination of the communication to the printer PT2, and then continues printing.

### BACKGROUND OF THE INVENTION

1. Field of the Invention

The present invention relates to a print job management system that receives a plurality of print jobs from a print job submitting device such as a computer, manages these print jobs, and thereby appropriately activates a plurality of printers to print these print jobs.

2. Description of the Related Art

In recent years, because of the diffusion of LAN (local area network) and the like, an aspect is coming into widespread use in which a printer is connected to a network and is shared by a plurality of computers (hereinafter referred to as “the clients”) that are also connected to the network. The printer receives a plurality of print jobs from the clients. In order to print these print jobs, each printer is embedded with or is externally equipped with a spool buffer for storing print jobs. The print jobs are temporarily stored in the spool buffer and are transferred to the printer one after another so as to execute printing.

A load sharing print system is becoming prevalent, which collectively manages and controls a plurality of printers that are connected to a single network and effectively performs print processing. The load sharing print system is capable of, for example, in case where one of the printers has an error, transferring print jobs of the printer to another printer to print the jobs, or in case where one of the printers has an amount of waiting jobs being equal to or greater than a predetermined level, transferring print jobs of the printer to another printer that has a smaller amount of waiting jobs to print the jobs.

There are two types of print jobs: jobs that can be printed by any printer based on their data as long as the data is transmitted from the client in a predetermined format such as in raster images (hereinafter referred to as “the remote type print jobs”); and jobs that presuppose an establishment of two-way communication between the client and the printer (hereinafter referred to as “the two-way type print jobs”). The latter type includes print jobs that have drawing contents to be printed described in “PostScript (a trademark registered)” language rather than in raster images.

In the process of printing a two-way type print job, various pieces of information are exchanged between the printer and the client, including version information of PostScript, a list of fonts that are supported on the printer's side, and such. The two-way type print job thus cannot be simply stored in a spooler.

A technique that is recited in JAPANESE PATENT LAYING-OPEN GAZETTE No. 2001-202219 can be proposed as an example of the technique that appropriately manages and controls the two-way type print jobs. According to the proposed technique, in case where a two-way type print job is sent out from the client, only job information of the job is stored in the spooler, and the job is printed in connection with a two-way communicating that is established between the printer and the client without going through the spooler.

However, in case where the spooled job information is moved to another spooler, the client that submitted the job and the printer to which the job information is moved may be unable to establish the two-way communication therebetween, which may result in unprintability of the job.

### SUMMARY OF THE INVENTION

The object of the present invention is thus to provide a technique that enables the move of the spooled two-way type print job between the print devices.

A first configuration of the present invention relates to a print job management system that is disposed corresponding to each print device and manages print jobs, in a system in which a print job submitting device and a plurality of print devices are connected via a network. The print job management system includes:

a job storage unit that, when a request to execute a two-way type print job, which is to be executed in connection with a two-way communication between the print job submitting device and the print device, is received from the print job submitting device, stores predetermined data for job-control that is other than the print job itself; a print job execution unit that, when it is determined that a timing of printing the two-way type print job is reached according to the predetermined data, establishes the two-way communication between the print job submitting device and the print device and thereby executes printing;

a storage location change unit that, when an instruction for moving the print job to another print device is input, changes a storage location of the predetermined data to another print job management system that corresponds to another print device; and

a notification unit that provides a notification of the change in the storage location to the print job submitting device.

The print job submitting device includes a variety of equipments that generate image data or document data to be printed, such as computers, facsimiles, and digital cameras.

According to the present invention, the two-way communication can be established between the print job management device that corresponds to a new print device and the print job submitting device and thereby execute printing, even in case where the storage location of the predetermined data that specifies the two-way type print job is changed.

The storage location can be changed in various ways. For example, the predetermined data may be moved to another print job management system, or the print job submitting device may delete the predetermined data and re-submit the print job to another print device. The former is advantageous in that processing is relatively easy, whereas the latter is advantageous in that the load on the network can be reduced.

A second configuration of the present invention may relate to a print job management system (hereinafter referred to as “the new print job management system”) that includes a change notification unit that, when information on change of a storage location of a two-way type print job is received from another print job management system (herein referred to as “the original print job management system”) that received a request to print the two-way type print job from a print job submitting device, stores predetermined data into a job storage unit and provides a notification of the change in the storage location to the print job submitting device that submitted the two-way type print job. The information on change of the storage location corresponds to a request to print that is submitted from a print job management system to another print job management system. In the second configuration, not the original print job management system but the new print job management system provides the notification of change to the print job submitting device. According to the notification of change, the print job submitting device can establish a two-way communication with a new print device and thereby execute printing.

In the second configuration, the information on change in the storage location may include information for specifying the print job submitting device and an instruction for changing the storage location. The change notification unit may require a re-submitting of the print job to the print job submitting device that is specified by the information on change in the storage location.

The information that specifies the print job submitting device may be a source address that is included in the print job, for example. The instruction for changing may be a combination of a new storage location and a file name of the print data. In this way, the print job management system can provide the notification of change in the destination of the print job to the print job submitting device.

In the print job management system of the present invention, the information on change in the storage location may be predetermined data. Since the predetermined data can include the information for specifying the print job submitting device, the print job management system can provide the notification of change in the storage location of the predetermined data to the print job submitting device. In this way, the print job can be printed without reissuing the predetermined data in the print job management system nor reissuing the print job in the print job submitting device.

A third configuration of the present invention relates to a print job management system that manages print jobs in a system in which a print job submitting device and a plurality of print devices are connected via a network. In the print job management system,

a spooler is disposed corresponding to each of the print devices; and

when a request to execute a two-way type print job, which is to be executed in connection with a two-way communication between the print device and the print job submitting device, is received, the spooler stores predetermined job-for job control that is different from the print job itself,

the print job management system may include:

a move detection unit that detect a move of the predetermined data between the respective spoolers; and

a change notification unit that, when the move is detected, provides a notification of change in a storage location to the print job submitting device.

The print job management system monitors the spoolers corresponding to the plurality of print devices, and when a change in the storage location of the job is detected between the respective spoolers, the print job management system can provide a notification to the submitter of the print job. In this way, printing can be executed without trouble even after the move of the two-way type print job.

The third configuration may further include an instruction input unit that inputs a move instruction to move a print job, which is stored in a spooler for a print device under the management, to another print device also under the management. Information regarding the print devices under the management of the print job management system may include operating states, amounts of data stored in the spoolers, and the like, for example. When one of the print devices under the management became unprintable, for example, the print job management system can continue with printing by transferring the print job to another print device under the management. In this way, it is possible to reduce the load of each print device and improve the efficiency of printing.

In either configuration of the first through the third, the predetermined data may be data that is set uniquely for the two-way type print job in a format that is not representable of the entire drawing contents of the print job, or may be a part of data that constitutes the print job. The term “The format that is not representable of the entire drawing contents of the print job” does not include the data that represents the entire print job. The term “set uniquely for” only requires the data to be in a format that is at least capable of specifying the one's being a two-way type print job. As the predetermined data, the data in a range that does not require a two-way communication may be used, such as a beginning part of the data that constitutes the print job, for example. Accordingly, it is only necessary to receive unreceived packets in execution of the print job. In this way, the load on the print device can be reduced.

The two-way type print job includes a job that is described in “PostScript (a trademark registered)” language, for example. Since the print job described in “PostScript” language is typically attached with a comment “%!PS-Adobe . . . ”, the job may be determined whether or not being a two-way type print job according to the presence or absence of such a comment. The predetermined data may also be a packet that is already received at that time.

The print job management system of the present invention may further include:

a hold instruction unit that, at the time of receiving the two-way type print job, causes the print job submitting device to put the transmission of the print job on hold. The hold instruction unit may send a signal to stop the transmission of the print job, for example, at the time when the received print job is recognized as a two-way type print job. In such a case, it is only necessary to restart receiving unreceived packets in execution of the print job. In this way, it is possible to manage and control the two-way type print job without receiving the entire print job.

In the print job management system of the present invention,

the notification of change may include information that specifies another print device and information that represents a new storage location of the predetermined data. The information for specifying another print device may be an address of another print device, for example. In this way, the print job submitting device can establish a two-way communication based on the new storage location and thereby execute printing.

In the print job management system of the present invention, a variety of aspects are possible for the instruction input unit. For example, the instruction for moving the print job may be input manually by a user, or may be input automatically by the print job management device according to an operating state of the print device or an amount of data of the printer waiting jobs in the spooler.

The operating state of the print device may be a status of the print device, for example. The status may include “Ready (printable)”, “Busy (printing)”, “Error (unprintable)”, and the like. The print job management device may move the print jobs remaining in the spooler to another print device when the status of the print device under the management becomes “Error”, or may move the print jobs remaining in the spooler to another print device with a relatively small amount of printer waiting jobs when the number of the printer waiting jobs in the printer under the management exceeds a predetermined level.

A fourth configuration of the present invention relates to a print job submitting device that, in a system to which a plurality of print devices are connected, submits a print job to one of the print devices, where

in the network, a print job management system is disposed for each of the print devices for controlling print job execution,

the print job submitting device may include:

a communication establishment unit that, in execution of a two-way type print job that requires a two-way communication with the print device at the time of printing, establishes a two-way communication with the print device according to an instruction from the print job management system; and

a communication switch unit that, when a notification of change, which represents that the print device for print job execution was changed, is received from one of the print job management systems, switches a destination of the two-way communication to a new print device.

In this way, the print job submitting device can stop the processing for establishing the two-way communication with the print device that was designated as a destination of output, establish a two-way communication with another print device that became a new destination of output, and thereby continue printing.

In addition to the configurations as a print job management device and a print job submitting device, the present invention can also be configured as inventions of a method of managing print jobs and a method of printing print jobs. The present invention can also be implemented in various aspects, such as a computer program for implementing the configurations described above, a recording medium that is recorded with the program, or data signals that are embodied in carrier waves with the program included therein. The afore-mentioned various additional elements can also be applied to every one of the aspects.

In case where the present invention is configured as a computer program or a recording medium that is recorded with the program, the program may be configured to drive a print job management system as a whole, or may be configured that only a part of the program achieves the functions of the present invention. In addition, various computer-readable media can be employed as the recording medium, such as: flexible disk, CD-ROM, DVD-ROM, magneto-optical disk, IC card, ROM cartridge, punch card, printed matter that is printed with codes such as bar codes, and internal storage (memory such as RAM or ROM) and external storage of a computer.

### BRIEF DESCRIPTION OF THE DRAWINGS

FIG. 1 is a schematic that shows the general configuration of a print job management system as a first embodiment.

FIG. 2 is a schematic that shows the internal configuration of a print job management system in the first embodiment.

FIG. 3 is a flowchart of print processing in the first embodiment.

FIG. 4 is a flowchart of processing that changes a storage location of job information in the first embodiment.

FIG. 5 is a flowchart of processing that provides a notification of change in job information in the first embodiment.

FIG. 6 is a flowchart of processing that changes a storage location of job information in a second embodiment.

FIG. 7 is a flowchart of processing that changes a storage location of job information in a third embodiment.

FIG. 8 is a flowchart of processing that changes a storage location of job information in a fourth embodiment.

FIG. 9 is an example of an instruction screen to change a storage location of job information as a modification.

### DESCRIPTION OF THE PREFERRED EMBODIMENTS

Embodiments of the present invention are described below under the following sections.

A. First Embodiment:

A1. System Overview:

A2. Internal Configuration:

A3. Print Processing:

A4. Processing of Changing Storage Location:

A5. Instruction for Changing Storage Location:

B. Second Embodiment:

B1. Processing of Changing Storage Location:

C. Third Embodiment:

C1. Processing of Changing Storage Location:

D. Fourth Embodiment:

D1. Processing of Switching Communication:

E. Modifications:

A. First Embodiment:

A1. System Overview:

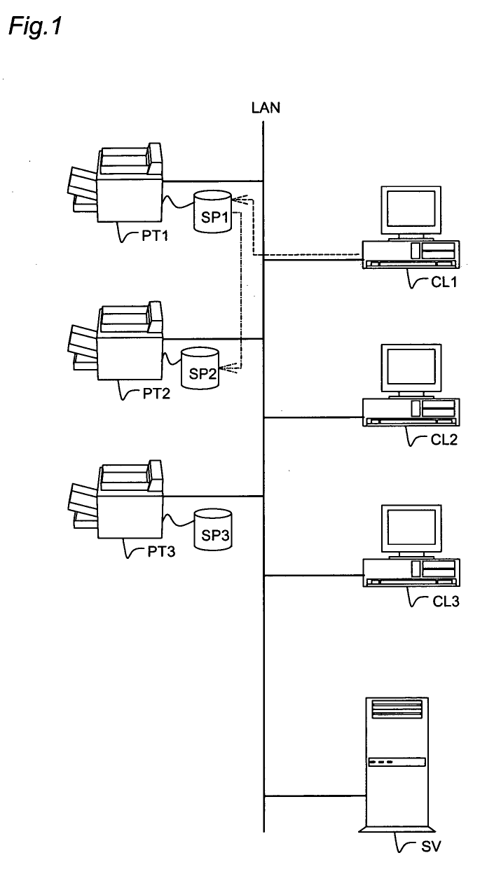

FIG. 1 is a schematic that shows the general configuration of a print job management system as a first embodiment. As shown, three client computers CL1, CL2, and CL3 (hereinafter collectively referred to as “the clients”), three printers PT1, PT2, and PT3, and a server SV are connected to a local area network LAN. Users of the clients CL1, CL2, and CL3 can activate any one of the printers to execute printing by specifying pathes corresponding to the respective printers PT1, PT2, and PT3 and then by sending print jobs. The printers PT1 through PT3 respectively incorporate print job management systems. Although the printers are respectively embedded with corresponding spoolers SP1, SP2, and SP3, the spoolers are shown external to the printers for ease of explanation.

A dashed line shows a flow of a print job that is output from the client CL1 to the printer PT1. In case where a two-way type print job that requires a two-way communication between the client CL1 and the printer PT1 is received, the print job management system of the printer PT1 stores only “job information” that corresponds to the print request. In case where a remote type print job that does not require a two-way communication is received, the print job management system stores job information and the entire print job.

In case where the printer PT1 became uncapable of continuing printing, the print job management system that is incorporated in the printer PT1 transfers jobs remaining in the spooler SP1 to the spooler SP2, as indicated by a chain line. In case where the job to be transferred to the spooler SP2 is the job information of a two-way type print job, the print job management system also provides a notification of the move of the job information to the client CL1 that is the submitter of the job.

When the two-way type print job is determined to be in its turn for printing according to the job information that is stored in the spooler SP2, the print job management system of the printer PT2 establishes a two-way communication with the client CL1 and accordingly obtains information necessary for printing and thereby executes printing.

The present embodiment takes up a case where an error occurs in the printer PT1 after the two-way type print job is sent from the client CL1 to the printer PT1.

A2. Internal Configuration:

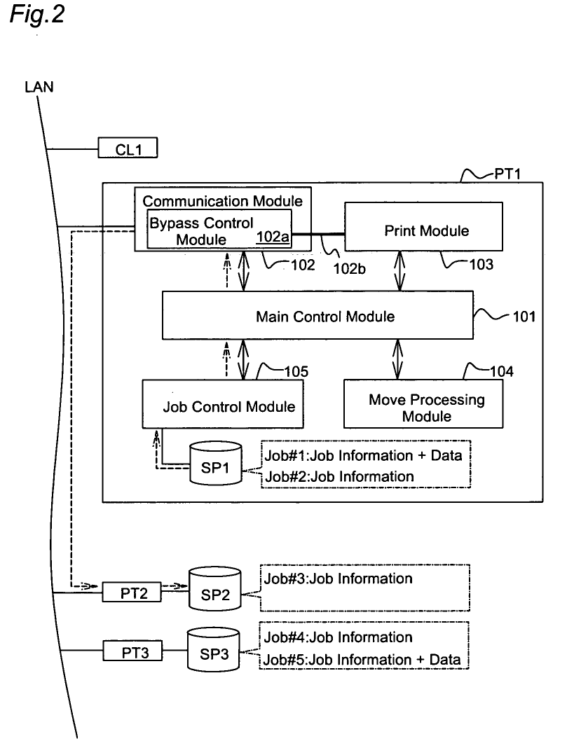

FIG. 2 is a schematic that shows the internal configuration of a print job management system in the present embodiment. Although FIG. 2 illustrates the printer PT1 as an example, the other printers also have similar configurations. The printer incorporates a control unit that is mounted with a microcomputer that includes a CPU and memories such as a RAM and a ROM. The control unit includes a main control module 101, a communication module 102, a bypass control module 102a, a print module 103, a move processing module 104, and a job control module 105. Each of the functional blocks is configured by software in the printer PT1 and is controlled by the main control module 101. Each of the functional blocks may also be configured by hardware.

The communication module 102 sends and receives data to and from the other devices on the network LAN. When a print job is received, the communication module 102 transfers the print job to the job control module 105 via the main control module 101. The job control module 105 analyzes the received print job, and in case where the job is a two-way type print job, only stores job information in the spooler SP1 and sends out a wait signal that puts the transmission of the job on standby. In case the received job is a remote type print job, the job control module 105 stores job information and the entire body of data into the spooler SP1.

In FIG. 2, a first and second print jobs #1, #2 are shown being stored in the spooler SP1. The print job #1 is a remote type print job and is stored with job information and print data that represents drawing contents. The print job #2 is a two-way type print job and is stored with job information only. Similarly, print jobs #3, #4 are two-way type print jobs and a print job #5 is a remote type print job. In the present embodiment, the print job is considered to be necessary of establishing a two-way communication and only the job information is stored, only when the job is described in PostScript language.

The wait signal is not necessarily a signal that is unique to the present embodiment, but may be sent out as data that notifies the client of an unreceivable state on the printer based on a protocol on the network.

The job control module 105 also functions to execute print jobs that are stored in the spooler SP1 one after another. The print jobs stored in the spooler SP1 are sent to the print module 103 one after another. In case where the sent out job is a remote type print job such as the job #1 illustrated in FIG. 2, printing is attained by sending out its body data to the print module 103.

On the other hand, in case where the sent out job is a two-way type print job such as the job #2, printing is executed in the following order, since the body data of the job is not stored in the spooler SP1. As shown, the communication module 102 includes the bypass control module 102a. In execution of the two-way type print job, the job control module 105 instructs the communication module 102 to activate the bypass control module 102a and commits the control of print job execution to the bypass control module 102a. When activated, the bypass control module 102a by software establishes a bypass 102b, which conducts data exchange without going through the spooler SP1, between the communication module 102 and the print module 103, as indicated by a heavy line in FIG. 2. In addition to the establishment of the bypass 102b, the bypass control module 102a outputs a signal that permits the transmission of the print job to the client that is in standby not sending the two-way type print job. As a result, printing is executed in connection with a two-way communication that is established between the client CL1 and the print module 103 of the printer PT1.

The move processing module 104 moves the print jobs stored in the spooler SP1 to another printer on the same network. The move processing module 104 monitors an operating status of the printer PT1 and an amount of data of the print jobs in the spooler SP1 at predetermined intervals. The operating status indicates “Ready (printable)”, “Busy (printing)”, “Error (unprintable)”, and the like. When the operating status of the printer PT1 is detected to be “Error”, the move processing module 104 obtains operating statuses of other printers on the network and amounts of data of print jobs in the spoolers corresponding to the respective printers, determines to which spooler the data remaining in the spooler SP1 can be moved, and instructs the job control module 105 to attain the move. Suppose the printer to which the jobs can be moved is the printer PT2 in the present embodiment, the move processing module 104 then moves the job information from the spooler SP1 to the spooler SP2, as indicated by a dashed line in FIG. 2. In case where the print jobs to be moved are two-way type print jobs such as the job #2, the move processing module 104 provides a notification of change to the client or the submitter of each print job via the communication module 102, in addition to the instruction for moving.

The notification of change that is provided from the move processing module 104 to the client includes an address of the printer that is a destination of the move of the job information and an instruction for switching a destination of the communication. The client CL1 that has sent a two-way type print job to the printer PT1 is in standby not sending the print job body data until the job comes into its turn for execution. The notification of change is provided so that the client can cancel the holding of data and prepare for the sending of the body data to the new printer.

With the device configurations as described above, even in case where an error occurs after job information of a two-way type print job is stored in the spooler SP1, the printer PT1 of the present embodiment can attain printing by moving the job information to another printer on the network and then providing a notification of change in the job information to the job-issuing client CL1. The following describes print processing that takes place when a two-way type print job is sent from the client CL1 and control processing that causes another to execute printing when an error occurs.

A3. Print Processing:

The following illustrates print processing that takes place when a two-way type print job is sent out from the client CL1 to the printer PT1.

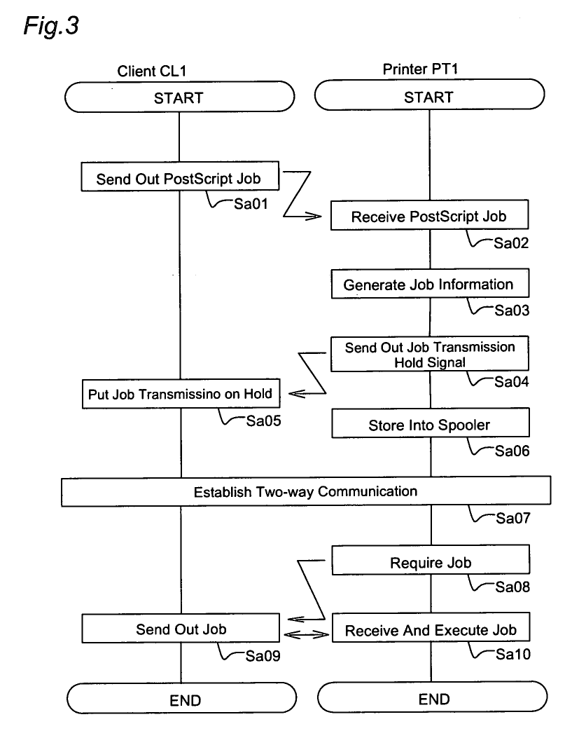

FIG. 3 is a flowchart of print processing in the present embodiment. The client CL1 sends to the printer PT1 a print job that is described in PostScript language in step Sa01. The communication module 102 receives packets of the print job in step Sa02 and transfers the packets to the job control module 105. The job control module 105 determines whether or not the transferred print job is described in PostScript language, and in case where the print job is determined to be described in PostScript language, generates job information in step Sa03. Next, the job control module 105 sends to the client CL1 a signal that puts the transmission of the print job on hold in step Sa04, and stores the job information in the spooler SP1 in step Sa06. When the hold signal is received, the client CL1 stops the sending of the print job and waits until a release signal is received in step Sa05.

When it is recognized that a timing of printing the two-way type print job is reached according to the stored job information, the job control module 105 activates the bypass control module 102a and establishes a two-way communication by the bypass 102b between the client CL1 and the print module 103 in step Sa07.

When the two-way communication is established, the bypass control module 102a sends the release signal to the client CL1 and requires the unsent job in step Sa08. In this way, printing is executed by exchanging a variety of information while repeatedly conducting the process of sending the job by the client CL1 in step Sa09 and the process of receiving and printing the job by the printer PT1 in step Sa10.

A4. Processing of Changing Storage Location:

The following illustrates processing for executing printing by transferring a two-way type print job that is stored in the printer PT1 to the printer PT2.

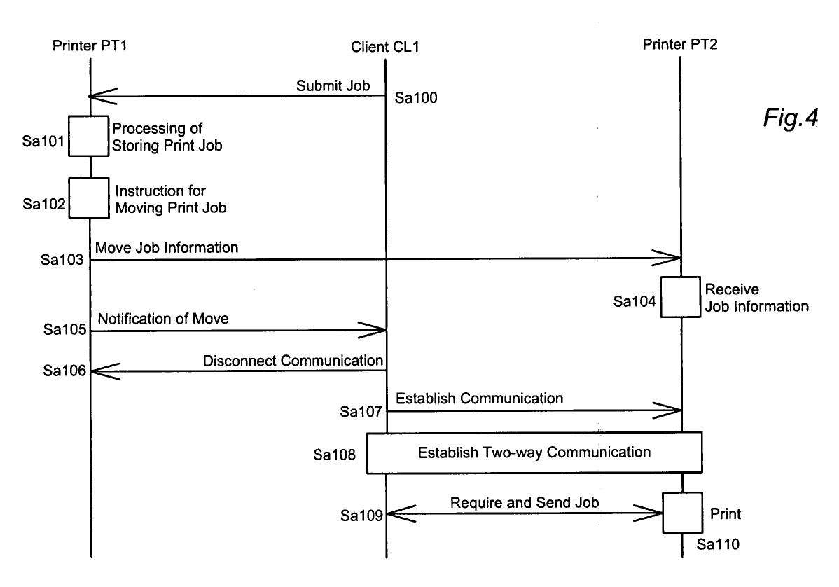

FIG. 4 is a flowchart of processing that changes a storage location of job information in the present embodiment. The client CL1 submits to the printer PT1 a print job that is described in PostScript language in step Sa100. The printer PT1 receives the job, generates job information, and stores the information into the spooler SP1 in step Sa101 which corresponds to the processing from Sa02 to Sa06 in FIG. 3. Next, the printer PT1 detects an error and submits an instruction for moving the job information that is stored in the spooler SP1 to the printer PT2 in step Sa102. Details regarding the instruction for moving the print job will be described later.

The printer PT1 moves the job information to the printer PT2 based on the instruction for moving in step Sa103, and provides a notification of change to the client CL1 in step Sa105. The printer PT2 receives the job information and stores the information into the spooler SP2 in step Sa104.

When the notification change in the job information is received, the client CL1 disconnects the communication with the printer PT1 in step Sa106, and carries out processing of establishing a communication with the printer PT2, which is a destination of the move of the job information, in step Sa107.

When the print job that was submitted by the client CL1 comes into its turn for printing, the printer PT2 establishes a two-way communication with the client CL1 in step Sa108, and executes printing in step Sa110 while exchanging information in step Sa109.

A5. Instruction for Moving:

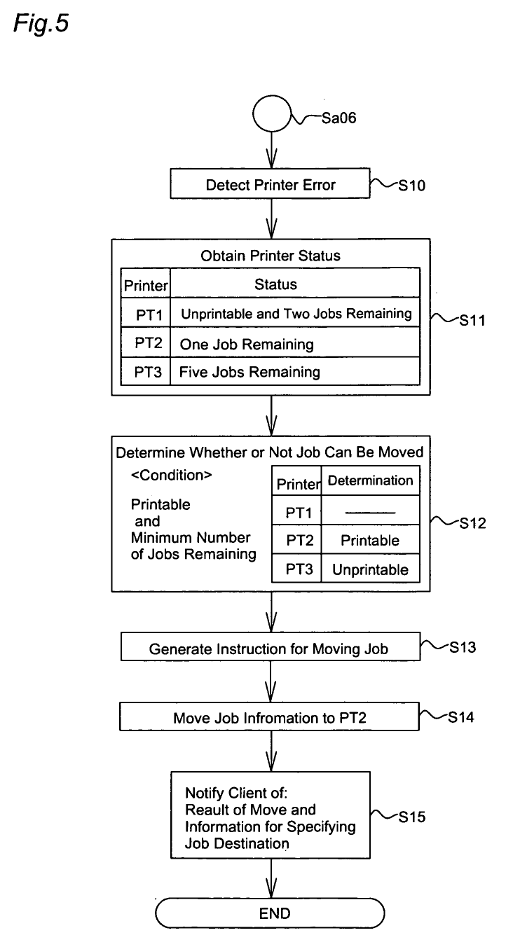

FIG. 5 is a flowchart of processing in which the printer PT1 provides a notification of change to the client CL1. The processing is started when an error occurs in the printer PT1 in or after step Sa06 in FIG. 3, and is carried out by the main control module 101 by controlling other functional blocks.

When an error is detected in step S10, the move processing module 104 obtains operating statuses of the printers PT2, PT3 that exist on the same network in step S11. The status of each printer is shown in FIG. 5: the printer PT1 is unprintable due to the error and the spooler SP1 has two jobs in printer waiting; the printer PT2 is printable and the spooler SP2 has one job in printer waiting; and the printer PT3 is printable and the spooler SP3 has two jobs in printer waiting.

The move processing module 104 collates the operating status of each printer with a predetermined condition and determines whether or not the printer is appropriate to be a destination of the move, in step S12. In the present embodiment, the predetermined condition is that the printer is “printable and has minimum number of jobs in printer waiting in its spooler”. In this case, the printer PT2 is determined to satisfy such a condition. Based on the result of determination, the move processing module 104 generates an instruction for moving the print job and inputs the instruction into the job control module 105, in step S13.

According to the input instruction for moving, the job control module 105 moves the two jobs in printer waiting in the spooler SP1 into the printer PT2 in step S14. In case where the job to be moved includes the job information that indicates one's being a two-way type print job, the move processing module 104 then provides a notification of change to the client that is the submitter of the print job, in step S15.

According to the print job management device of the first embodiment described above, it is still possible to move the job information can be moved to another printer on the same network and the job can be printed with a relatively light load, even in case where an error occurs in the printer that was designated as a destination to output the two-way tupe print job.

B. Second Embodiment:

In the first embodiment, at the time the job information moves, the print job management system corresponding to the original printer provides the notification of change to the client or the submitter of the job. On the contrary, in the second embodiment, the print job management system corresponding to the new printer provides the notification of change to the client or the submitter of the job. The printers PT1, PT2 and the client CL1 in the present embodiment are similar to those in the first embodiment.

B1. Screen of Instruction for Changing Storage Location:

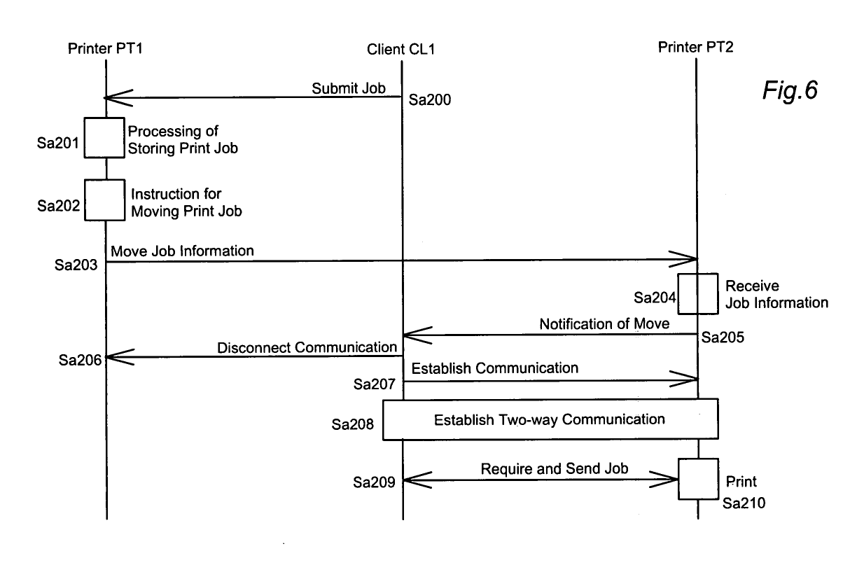

FIG. 6 is a flowchart of processing that changes a storage location of job information in the second embodiment. Processing from the issuance of a job by the client CL1 in step Sa200 to the move of job information in step Sa203 are similar to the processing from step Sa100 to step Sa103 in FIG. 4 that are described above in the first embodiment, and thus are not described again.

The printer PT2 specifies the client CL1 or the submitter of the job according to the received job information and generates a notification of change, in step Sa204, and provides the notification of change to the client CL1 in step Sa205. The notification of change includes address information that specifies the printer PT2 and an instruction for switching the two-way communication.

The processing of switching a destination of communication by the client CL1 and the processing of printing through the two-way communication between the client CL1 and the printer PT2 are similar to the processing from step Sa106 to step Sa110 in FIG. 4 that are described above in the first embodiment.

According to the print job management system of the second embodiment described above, the notification of change can be provided by the new printer even in case where the original printer cannot provide the notification of change to the submitter of the job at the time the job information moves.

C. Third Embodiment:

In the first and second embodiments, the print job management systems that are incorporated in the printers PT1 and PT2 provide the notification of change in the job information, respectively, whereas in the third embodiment, the server SV detects the move of the job information and provides the notification of change. As shown in FIG. 1, the server SV exists on the same network as the printer PT1, the printer PT2, and the client CL1, and incorporates the print job management system of the first embodiment. The server SV monitors operating statuses of the printers on the same network and amounts of data in the spoolers corresponding to the respective printers at predetermined intervals. The printers PT1, PT2 and the client CL1 in the present embodiment are similar to those in the first embodiment. It should be noted, however, that neither the printer PT1 nor the printer PT2 provides the notification of change in the present embodiment.

C1. Processing of Changing Storage Location:

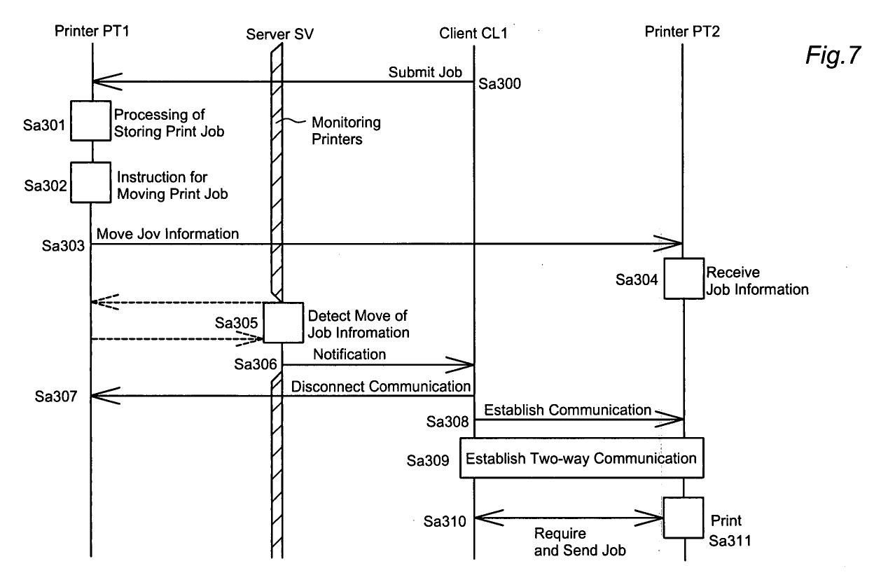

FIG. 7 is a flowchart of processing that changes a storage location in the third embodiment. Processing from the issuance of job by the client CL1 in step Sa300 to the move of job information in step Sa303 are similar to the processing from step Sa106 to step Sa110 in FIG. 4 that are described above in the first embodiment, and thus are not described again.

The printer PT2 receives the job information from the printer PT1 and accordingly stores the information into the spooler SP2, in step Sa304. The server SV monitors the printers on the same network at predetermined intervals, and when a move of the job information is detected in step Sa305 as indicated by dashed arrows, the server SV provides a notification of change to the client CL1 or the submitter of the job in step Sa306. Shaded areas in FIG. 7 represent the monitor processing that is conducted by the server SV at predetermined intervals over the respective printers on the network.

The processing of switching a destination of communication by the client CL1 and the processing of printing through the two-way communication between the client CL1 and the printer PT2 (steps Sa307 through Sa311) are similar to the processing from step Sa106 to step Sa110 of FIG. 4 in the first embodiment.

In this way, loads on the printers PT1, PT2 can be reduced and the efficiency of printing can be improved.

Although in the present embodiment, the server SV monitors operating statuses of the printers on the same network and amounts of data in the spoolers corresponding to the respective printers at predetermined intervals, the notification of change may also be provided by the printer PT1 or the printer PT2 to the server SV. In such a case, the server SV receives the notification of change and carries out the processing of or after step S306.

D. Fourth Embodiment:

In the first through third embodiments, printing is carried out by moving the job information itself to another printer. On the contrary, in the fourth embodiment, printing is carried out by deleting the job information from the spooler of the printer PT1 and causing the client CL1 to re-submit the job to the printer PT2 that is newly designated for printing. The printers PT1, PT2 and the client CL1 in the present embodiment are similar to those in the first embodiment. It should be noted, however, that the job is deleted by the job control module 105 based on the instruction for moving that was received from the move processing module 104.

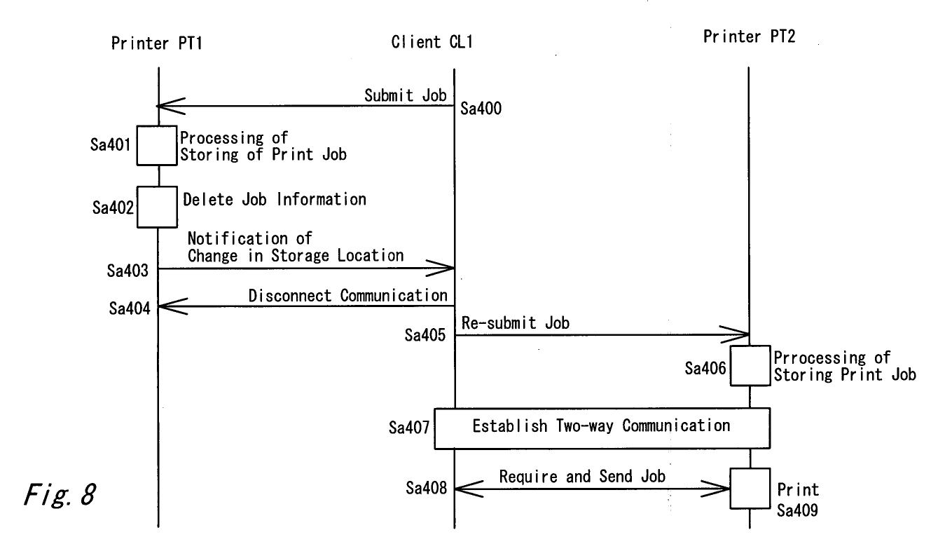

FIG. 8 is a flowchart of processing that changes a storage location in the fourth embodiment. The client CL1 submits a two-way type print job to the printer PT1 in step Sa400. When the print job is determined to be a two-way type print job according to a first packet of the job, the printer PT1 stores job information into the spooler SP1 in step Sa401. Next, the printer PT1 detects an error, deletes the job information that is stored in the spooler SP1 in step Sa402, and provides address information of the printer PT2 that is a new destination of output and an instruction for reissuing the print job, as a notification of change in a storage location, to the client CL1 in step Sa403.

When the notification of change in a storage location of the job is received, the client CL1 disconnects the communication with the printer PT1 in step Sa404, and resubmits the print job to the printer PT2 in step Sa405.

When the print job is received, the printer PT2 determines that the job is a two-way type print job, generates job information, and stores the job information into the spooler SP2, in step Sa406. When the stored job information comes in its turn for printing, the printer PT2 establishes a two-way communication with the client CL1 in step Sa407, and executes printing in step Sa409 while exchanging information in step Sa408.

Since there is no need for moving the job information in this way, the load on the network can be reduced and the efficiency of printing can be improved.

Although the job information remaining in the spooler SP1 is moved to another printer in the event of an error in the first through the fourth embodiment of the present invention, the job information is not necessarily treated in this way. For example, the job information may be moved in the event when the total amount of data of jobs in printer waiting or the number of jobs in printer waiting exceeds a predetermined threshold value.

Although in step S12 of the first embodiment, the condition for determination on whether or not the job can be moved is set to have the printer “being printable and has minimum number of jobs in printer waiting”, the destination of the move may also be determined according to the size of paper for printing. For example, priorities may be set previously among the printers and the destination of the move may be determined according to such priorities. The condition for determination on whether or not the job can be moved may be set in various ways.

Although in step S13 of the first embodiment, the instruction for moving the job is generated automatically by the print job management system based on the result of determination on to which printer the job is to be moved, the instruction may also be designated arbitrarily by user.

In the fourth embodiment, the server SV not only detects and notifies the move of the job information, but may also input the instruction for moving based on the obtained information regarding the respective printers and thereby control the print job.

Steps Sa04 and Sa05 of the first embodiment may also be in reverse order. That is to say, the printer PT1 may receive a two-way type print job, generate job information, send out a hold signal, which puts the transmission of the job on hold, to the client CL1, and thereafter store the information into the spooler SP1, or the printer PT1 may also generate job information, store the information into the spooler SP1, and thereafter send out a hold signal that puts the transmission of the job on hold.

Although various embodiments of the present invention are described above, it is clearly understood that the present invention is not restricted to these embodiments, but there may be various configurations without departing from the spirit of the present invention. For example, the above-described control processing that is realized by software may also be realized by hardware.

E. Modifications:

E1. Modification 1:

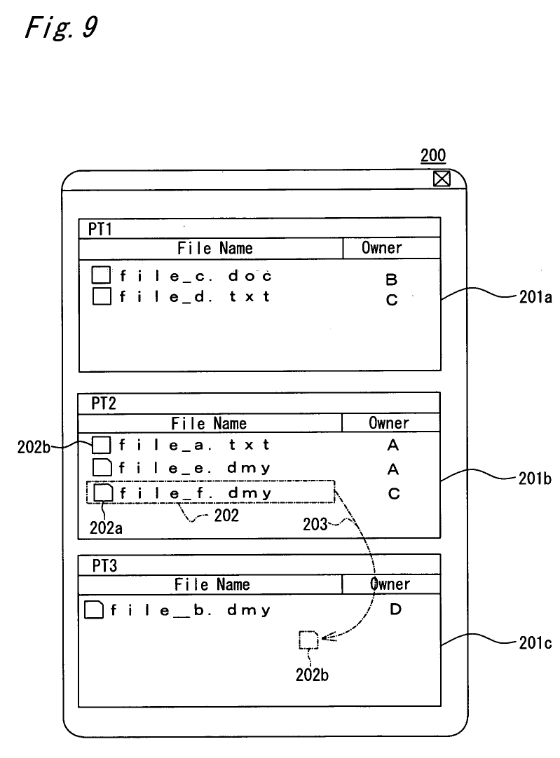

FIG. 9 is a schematic that shows an example of an instruction screen in which a user of job information provides an instruction for moving. The client CL1 is installed with software that is capable of checking the spoolers of the printers on the same network, and the user can move every kind of job to any of the printers as long as the job is submitted by the user itself. In the present embodiment, the user inputs an instruction for moving job information to the printer PT3. The job information is stored in the spooler SP2 and is owned by the user to the printer PT3.

A job checking screen 200 that is installed by software into the client CL1 is comprised of: a SP1 information display element 201a that shows contents of the spooler SP1; a SP2 information display element 201b that shows contents of the spooler SP2; and a SP3 information display element 201c that shows contents of the spooler SP3. Each of the job information is configured as a file with an extension of “dummy”. Types of jobs are categorized by icons, i.e. a job information icon 202a that represents the one's being job information and a remote type job icon 202b that represents the one's being a remote type print job. In FIG. 9, icons with chipped upper right corners represent the job information icons 202a.

The following describes processing in which a user C moves a job 202, which is owned by the user C, to the printer PT3. The user C moves the job 202 from the SP2 information display element 201b to the SP3 information display element 201c on the screen, as indicated by a route 203 in a chain line, through a drag and drop by e.g. a mouse.

The move processing module 104 detects this processing and transfers the processing to the job control module 105 in the form of an instruction for moving. When the instruction for moving is received, the job control module 105 actually moves the job and provides a notification of change to the submitter of the job.

In this way, either a remote type print job or a two-way type print job can be moved arbitrarily by the user, thereby improving the efficiency of printing.

E2. Modification 2:

Although the spoolers are embedded into the respective printers in the first through the fourth embodiments of the present invention, the spoolers are not necessarily configured in this way. For example in FIG. 1, the spoolers SP1 through SP3 may also be incorporated in the server SV. In such a case, the client CL1 or the submitter of a job designates a printer to be a destination of output and sends out the print job to the server SV

The server SV stores the received print job into the spooler that corresponds to the specified printer one after another, and when the job comes into its turn for printing, transfers the print job to the printer and thereby executes printing. In case where the stored print job is job information that indicates the one's being a two-way type print job, the server SV establishes a two-way communication with the client CL1 as well as with the printer PT1. The server SV then receives the print job from the client CL1 and transfers the job to the printer PT1 without going through the internal spooler SP1. The is to say, printing is performed through the two-way communication that is established between the client CL1 and the printer PT1.

In this way, the client CL1 can continue printing without paying attention to the change of the destination of the print job even in the event when the job information is moved between the spoolers. The loads on the client CL1 and the printers can thus be reduced.

What is claimed is:

1. In a system in which a print job submitting device and a plurality of print devices are connected via a network, a print job management system that is disposed corresponding to each of said print devices and manages print jobs, said print job management system comprising:
a job storage unit that, when a request to execute a two-way type print job, which is to be executed in connection with a two-way communication between said print job submitting device and the print device, is received from said print job submitting device, stores predetermined data for job-control that is different from said print job itself;
a print job execution unit that, when it is determined that a timing of printing said two-way type print job is reached according to said predetermined data, establishes a two-way communication between said print job submitting device and said print device and thereby executes printing;
a storage location change unit that, when an instruction for moving said print job to another print device is input, changes a storage location of said predetermined data to another print job management system that corresponds to said another print device; and
a notification unit that provides a notification of change in the storage location to said print job submitting device.

2. A print job management system according to claim 1, wherein
said storage location change unit moves said predetermined data to said another print job management system.

3. A print job management system according to claim 1, wherein
said storage location change unit deletes said predetermined data and causes said print job submitting device to resubmit said print job to said another print device.

4. A print job management system according to claim 1, wherein
said predetermined data comprises a part of data that constitutes said print job.

5. A print job management system according to claim 1, further comprising:
a hold instruction unit that, at the time of receiving the request to execute said two-way type print job, causes said print job submitting device to put the transmission of said print job on hold.

6. A print job management system according to claim 1, wherein
said notification of change includes:
information that specifies said another print device; and
information that represents a new storage location of said predetermined data.

7. In a system in which a print job submitting device and a plurality of print devices are connected via a network, a print job management system that is disposed corresponding to each of said print devices and manages print jobs, said print job management system comprising:
a job storage unit that, when a request to execute a two-way type print job, which is to be executed in connection with a two-way communication between said print job submitting device and the print device, is received from said print job submitting device, stores predetermined data for job-control that is different from said print job itself;
a print job execution unit that, when it is determined that a timing of printing said two-way type print job is reached according to said predetermined data, establishes a two-way communication between said print job submitting device and said print device and thereby executes printing; and
a change notification unit that, when an instruction for changing a storage location of said two-way type print job is received from another print job management system that received a request to print said two-way type print job from said print job submitting device, stores said predetermined data in said job storage unit and provides a notification of change in the storage location to said print job submitting device that submitted said two-way type print job is submitted.

8. A print job management system according to claim 7, wherein
information on change of the storage location at least includes information for specifying said print job submitting device and instruction for changing the storage location; and
wherein by means of said notification of change, said change notification unit requires said print job submitting device that is specified by said information on change of the storage location to resubmit said print job.

9. A print job management system according to claim 7, wherein
the information on change of the storage location comprises said predetermined data.

10. A print job management system according to claim 7, wherein
said predetermined data comprises a part of data that constitutes said print job.

11. A print job management system according to claim 7, further comprising:
a hold instruction unit that, at the time of receiving the request to execute said two-way type print job, causes said print job submitting device to put the transmission of said print job on hold.

12. A print job management system according to claim 7, wherein
said notification of change includes:
information that specifies said another print device; and
information that represents a new storage location of said predetermined data.

13. A print job management system that manages print jobs in a system in which a print job submitting device and a plurality of print devices are connected via a network, wherein
a spooler is disposed corresponding to each of said print devices; and
wherein when a request to execute a two-way type print job, which is to be executed in connection with a two-way communication between said print device and said print job submitting device, is received, said spooler stores predetermined data for job control that is different from said print job itself,
said print job management system comprising:
a move detection unit that detects a move of said predetermined data between said respective spoolers; and
a change notification unit that, when said move is detected, provides a notification of change in storage location to said print job submitting device.

14. A print job management system according to claim 13, wherein
said predetermined data comprises a part of data that constitutes said print job.

15. A print job management system according to claim 13, further comprising:
a hold instruction unit that, at the time of receiving the request to execute said two-way type print job, causes said print job submitting device to put the transmission of said print job on hold.

16. A print job management system according to claim 13, wherein
said notification of change includes:
information that specifies said another print device; and
information that represents a new storage location of said predetermined data.

17. In a network to which a plurality of print devices are connected, a print job submitting device that submits a print job to one of said print devices, wherein
in said network, a print job management system for controlling print job execution is disposed corresponding to each of said print devices,
said print job submitting device comprising:
a communication establishment unit that, in execution of a two-way type print job that requires a two-way communication with said print device at the time of printing, establishes a two-way communication with said print device according to an instruction from said print job management system; and
a communication switch unit that, when a notification of change, which represents that the print device for print job execution is changed, is received from one of said print job management systems, switches the destination of said two-way communication to a new print device.

18. In a system in which a print job submitting device and a plurality of print devices are connected via a network, a print job management method in a print job management system that is disposed corresponding to each of said print devices, said print job management method comprising the steps of:
(a) when a request to execute a two-way type print job, which is to be executed in connection with a two-way communication between said print job submitting device and the print device, is received from said print job submitting device, storing predetermined data for job-control that is different from said print job itself;
(b) when it is determined that a timing of printing said two-way type print job is reached according to said predetermined data, establishing a two-way communication between said print job submitting device and said print device and thereby executing printing;
(c) when an instruction for moving said print job to another print device is input, changing a storage location of said predetermined data to another print job management system that corresponds to said another print device; and
(e) providing a notification of change in the storage location to said print job submitting device.

19. In a system in which a print job submitting device and a plurality of print devices are connected via a network, a print job management method in a system that is disposed corresponding to each of said print devices and manages print jobs, said print job management method comprising the steps of:
(a) when a request to execute a two-way type print job, which is to be executed in connection with a two-way communication between said print job submitting device and the print device, is received from said print job submitting device, storing predetermined data for job-control that is different from said print job itself;
(b) when it is determined that a timing of printing said two-way type print job is reached according to said predetermined data, establishing a two-way communication between said print job submitting device and said print device and thereby executing printing; and
(c) when an instruction for changing a storage location of said two-way type print job is received from another print job management system that received a request to print said two-way type print job from said print job submitting device, storing said predetermined data and providing a notification of change in the storage location to said print job submitting device that submitted said two-way type print job.

20. A print job management method that manages print jobs in a system in which a print job submitting device and a plurality of print devices are connected via a network, wherein
a spooler is disposed corresponding to each of said print devices; and
wherein when a request to execute a two-way type print job, which is to be executed in connection with a two-way communication between said print device and said print job submitting device, is received, said spooler stores predetermined data for job control that is different from said print job itself,
said print job management method comprising the steps of:
(a) detecting a move of said predetermined data between said respective spoolers; and
(b) when said move is detected, providing a notification of change in storage location to said print job submitting device.

21. In a network to which a plurality of print devices and a print job submitting device are connected, a method of printing that controls said print job submitting device and thereby executes a two-way type print job, said two-way type print job requiring a two-way communication between the print device and said print job submitting device, wherein
in said network, a print job management system for controlling print job execution is disposed corresponding to each of said print devices,
said method of printing comprising the steps of:
(a) in execution of said two-way type print job, establishing a two-way communication with said print device according to an instruction from said print job management system; and
(b) when a notification of change, which represents that the print device for print job execution is changed, is received from one of said print job management systems, switching the destination of said two-way communication to a new print device.

22. In a system in which a print job submitting device and a plurality of print devices are connected via a network, a recording medium that is recorded with a computer program for causing a print job management system that is disposed corresponding to each of said print devices to manage print jobs, said computer program causing a computer to implement the functions of:
when a request to execute a two-way type print job, which is to be executed in connection with a two-way communication between said print job submitting device and the print device, is received from said print job submitting device, storing predetermined data for job-control that is different from said print job itself;
when it is determined that a timing of printing said two-way type print job is reached according to said predetermined data, establishing a two-way communication between said print job submitting device and said print device and thereby executing printing;
when an instruction for moving said print job to another print device is input, changing a storage location of said predetermined data to another print job management system that corresponds to said another print device; and
providing a notification of change in the storage location to said print job submitting device.

23. In a system in which a print job submitting device and a plurality of print devices are connected via a network, a recording medium that is recorded with a computer program for causing a print job management system that is disposed corresponding to each of said print devices to manage print jobs, said computer program causing a computer to implement the functions of when a request to execute a two-way type print job, which is to be executed in connection with a two-way communication between said print job submitting device and the print device, is received from said print job submitting device, storing predetermined data for job-control that is different from said print job itself;
when it is determined that a timing of printing said two-way type print job is reached according to said predetermined data, establishing a two-way communication between said print job submitting device and said print device and thereby executing printing;
when an instruction for changing a storage location of said two-way type print job is received from another print job management system that received a request to print said two-way type print job from said print job submitting device, storing said predetermined data and providing a notification of change in the storage location to said print job submitting device that submitted said two-way type print job.

24. A recording medium that is recorded with a computer program for managing print jobs in a system in which a print job submitting device and a plurality of print devices are connected via a network, wherein
a spooler is disposed corresponding to each of said print devices; and
wherein when a request to execute a two-way type print job, which is to be executed in connection with a two-way communication between said print device and said print job submitting device, is received, said spooler stores predetermined data for job control that is different from said print job itself,
said computer program causing a computer to implement the functions of:
detecting a move of said predetermined data between said respective spoolers; and
when said move is detected, provides a notification of change in storage location to said print job submitting device.

25. In a network to which a plurality of print devices and a print job submitting device are connected, a recording medium that is recorded with a computer program for executing a two-way type print job by said print job submitting device, said two-way type print job requiring a two-way communication between the print device and said print job submitting device, wherein
in said network, a print job management system for controlling print job execution is disposed corresponding to each of said print devices,
said computer program causing a computer to implement the functions of
in execution of said two-way type print job, establishing a two-way communication with said print device according to an instruction from said print job management system; and
when a notification of change, which represents that the print device for print job execution is changed, is received from one of said print job management systems, switching the destination of said two-way communication to a new print device.
